(19) United States
(12) Patent Application Publication
(10) Pub. No.: US 2023/0240320 A1
(43) Pub. Date: Aug. 3, 2023

(54) CHOCOLATE COMPOSITIONS

(71) Applicant: Cargill, Incorporated, Wayzata, MN (US)

(72) Inventors: Vanessa Barey, Marcq-en-Baroeul (FR); Gaelle Colette Marie-Hélène Gautier, Mons-en-Baroeul (FR)

(73) Assignee: Cargill, Incorporated, Wayzata, MN (US)

(21) Appl. No.: 18/001,925

(22) PCT Filed: Jun. 30, 2021
(86) PCT No.: PCT/US2021/039745

§ 371 Date: Dec. 15, 2022

(30) Foreign Application Priority Data
Jun. 30, 2020 (EP) 20183110.4

(51) Int. Cl. A23G 1/48; A23G 1/50; A23G 1/40; A23G 1/46

(52) U.S. Cl. CPC A23G 1/48; A23G 1/50; A23G 1/40; A23G 1/46

(57) ABSTRACT

The invention relates to the use of pulse flours as bulking agents in chocolate compositions. For example, a chocolate composition may include a pre-cooked pulse flour, a pulse flour that has been subjected to extrusion cooking, and/or a pulse flour that has been subjected to particle size reduction (e.g., milling and/or micronization).

### CROSS-REFERENCE TO RELATED APPLICATIONS

This application claims the benefit of European Application No. 20183110.4, filed Jun. 30, 2020, which is incorporated by reference herein in its entirety.

### FIELD OF THE INVENTION

The invention relates to chocolate compositions comprising pulse flours.

### BACKGROUND

Most chocolate compositions traditionally contain sugar (typically sucrose). Sugar serves several vital functions in chocolate. Most importantly, it provides sweetness. It also provides bulk and plays a significant role in the structure, volume and mouthfeel of the finished product. However, there is growing pressure on the food industry to use less sugar in order to reduce sugar consumption and associated health issues in the global population. Several countries have enacted laws requiring the sugar content of commercial foods to be below a certain threshold. Formulating foods without sugar or with reduced sugar content is challenging because a sugar replacement will ideally not only replace the sweetness of sugar, but also fulfil all its other various functions.

One known approach is to replace all or part of the sugar with bulking agents (also known as “fillers”), and optionally to use high-intensity sweeteners instead of sucrose. However, these bulking agents can negatively influence the organoleptic or rheological properties of the chocolate and tend to make them less desirable to consumers.

Pulse flour is commonly used in the food industry as a replacement for wheat flour in gluten-free baking. One function of the pulse flour in baking is to act as a thickener or bulking agent.

Whole pulse flours are generally a good source of protein, carbohydrate, dietary fibre, vitamins and minerals, but they are also high in anti-nutritional factors, such as lectins, polyphenols, trypsin inhibitors, and phytic acid. Anti-nutritional factors reduce nutrient utilization, thereby contributing to impaired gastrointestinal and metabolic performance. For example, trypsin inhibitors bind to and inactivate the enzyme trypsin, thus affecting protein digestion, whilst phytic acid lowers the bioavailability of some minerals. These anti-nutritional factors limit the utility of pulse flours in food.

Pulse-based ingredients have been used previously in chocolate, for example in WO2020065207 which discloses a protein-enriched chocolate containing pea protein isolate. However, such protein isolates would not be suitable as bulking agents.

The present invention aims to provide a sugar reduced chocolate composition with good texture and taste, but which avoids or ameliorates the aforementioned problems.

### SUMMARY OF THE INVENTION

The applicant unexpectedly found that pulse flour which has been pre-cooked can be used as an effective ingredient in chocolate making without introducing unacceptable levels of anti-nutritional factors. Pre-cooked pulse flour was found to be an effective bulking agent, which may be used for sugar reduction and/or protein enrichment in standard chocolate and/or as a dairy replacement in vegan chocolate. Surprisingly, it was also found that pre-cooked pulse flour imparts a unique and pleasant taste to chocolate.

In one aspect, the invention provides a chocolate composition comprising pulse flour. Advantageously, the pulse flour in the bulking agent is pre-cooked. Optionally, the pulse flour has been subjected to extrusion cooking.

The pulse flour may have been subjected to a particle size reduction technique, such as milling and/or micronization. In a preferred aspect of the invention, the pulse flour has been extruded and micronized.

The pulse flour may be selected from bean flour, pea flour, chickpea flour, lentil flour, vetch flour, lupine flour, and mixtures thereof. Preferably, the pulse flour is selected from pea flour, faba bean flour, and mixtures thereof.

Advantageously, the pulse flour is free or substantially free from anti-nutritional factors.

The invention also provides for the use of a bulking agent as defined above as a full or partial replacement for sugar and/or milk solids in a recipe for a chocolate composition, and/or to enrich the protein content of a chocolate composition, and/or as a flavouring agent in a chocolate composition.

The chocolate composition may comprise from 3 to 20 wt % pulse flour.

### DESCRIPTION OF INVENTION

When used in this specification and claims, the terms “comprises” and “comprising” and variations thereof mean that the specified features, steps or integers are included. The terms are not to be interpreted to exclude the presence of other features, steps or components. In contrast, the terms “consist” or “consisting of” as used herein should be interpreted to exclude the presence of other features, steps or components.

### Chocolate Composition

As used herein, the terms “chocolate” and “chocolate composition” refer to any composition comprising cocoa solids in any amount, notwithstanding that in some jurisdictions chocolate may be legally defined by the presence of a minimum amount of cocoa solids and/or compounds that comprise cocoa butter or cocoa butter substitutes. Advantageously, the term chocolate composition refers to a composition that meets a legal definition of chocolate in any jurisdiction (preferably the US and/or EU) and also includes any product (and/or component thereof) in which all or part of the cocoa butter is replaced by cocoa butter equivalents, replacers, or substitutes. The term chocolate composition may also refer to chocolate compositions comprising cocoa butter and edible solids other than cocoa solids and to “chocolate-like” compositions comprising a suspension of edible solids in a continuous fat phase other than cocoa butter (e.g. Caramac®). The term chocolate composition may refer to an entire food product and/or a component thereof. The chocolate may be a dark, milk, white, ruby, or crumb chocolate, or variants thereof known to the person skilled in the art. The chocolate composition may be suitable for various applications, including but not limited to extrusion, moulding, enrobing, coating, dipping (e.g. for dipping ice-cream), spraying, making chocolate bars, chunks, chips, crumbs, vermicelli and/or sprinkles.

Typically, the chocolate composition of the invention will comprise or consist of a fat-continuous phase throughout which solids, preferably particulate solids (such as cocoa solids and/or pulse flour) are dispersed. Advantageously, the chocolate composition will be a moldable composition (that is capable of taking on the shape of a mold as it solidifies and then being readily “demolded” or removed from the mold in its solid state, for example at around 15-20° C.). It will preferably have a water content of below 3%, preferably below 2% by weight, more preferably below 1%, more preferably below 0.5%, for example between 0.5 and 1% by weight. It will preferably not be in the form of an emulsion.

The chocolate composition of the present invention may be produced using any chocolate making technique that is known in the art. Traditional chocolate making processes typically involve blending chocolate liquor (obtained from grinding and liquefying cacao nibs) with other ingredients such as cocoa butter, sugar, milk or milk solids, emulsifiers, flavourings or other additives. The blended ingredients are then refined before being subjected to conching, and then tempering to form the final product. Chocolate processing influences the rheological and organoleptic properties of the finished chocolate. In particular, the particle size is reduced to a desirable range (typically around 20-50 μm) in the final chocolate composition for good mouthfeel and texture.

### Pulse Flour

Pulses are the dry edible seeds of plants in the legume family, whilst pulse flour is a powder obtained by de-hulling and grinding pulses. The pulse flour used in the present invention may be derived from any leguminous plant. Non-limiting examples of well-known leguminous plants include alfalfa, clover, beans, peas, chickpeas, lentils, lupins, mesquite, carob, soybeans, peanuts and tamarind. Pulse flour for use in the present invention may particularly be selected from the group consisting of bean flour, pea flour (Pisum sativum), chickpea flour, lentil flour, vetch flour, lupine flour, and mixtures of two or more thereof. More particularly, the pulse flour may be derived from, adzuki beans, anasazi beans, appaloosa beans, black beans, borlotti beans, cannellini beans, cranberry beans, great northern beans, kidney beans, lima beans, mung beans, navy beans, pinto beans, soy beans, faba beans (a.k.a fava beans or broad beans), chickpeas, cow peas, earth peas, sweet peas, pigeon peas, red, green, yellow, and brown lentils, and mixtures of two or more thereof. Preferably, the pulse flour is selected from pea flour, faba bean flour, and mixtures thereof. More preferably, the flour is pea flour. The term “pulse flour” is used herein to refer to whole pulse flour and shall not encompass extracts, concentrates or isolates formed from processing pulse flour. In particular, the term “pulse flour” shall not include protein extracts, protein concentrates or protein isolates such as Roquette's NATRALYS®XF pea protein isolate or ADM's Arcon-S soy protein concentrate.

Pulse flours contain high levels of anti-nutritional factors, which can be inactivated or eliminated by the application of high temperatures (around 100° C. or greater). Various heat treatments have been applied to pulses, such as boiling, roasting, microwaving, and extrusion cooking (Patterson et al. 2017, Effect of processing on Antinutrient compounds in pulses, Cereal chemistry, 94(1): 2-10—which is incorporated by reference). Extrusion cooking is a process that utilizes a combination of moisture, pressure, temperature, and mechanical shear. Extrusion cooking of pulses has been shown to significantly reduce or eliminate the levels of various anti-nutritional compounds (Berrios, J. D 2011. Extrusion processing of main commercial legume pulses. Pages 209-236 in Advances in Extrusion Technology M. Maskan and A. Altan, eds. CRC Press: Boca Raton, Fla.—which is incorporated by reference).

It is possible to use pulse flours in the baking industry because baking typically involves cooking at temperatures that reduce the amount of anti-nutritive factors.

However, chocolate making does not involve the use of high temperatures. Heat is applied during the conching process, but this is typically limited to between around 50° C. and 90° C., with most milk chocolates being conched below 70° C. Therefore, pulse flour has not previously been used before in chocolate.

However, the applicant unexpectedly found that pre-cooking pulse flour reduced or eliminated the levels of anti-nutritive compounds and minimised bitter tasting notes, allowing it to be used as a bulking agent in chocolate. As used herein, the term “pre-cooked” means that the pulse flour has been subjected to a heat treatment step prior to use (i.e. prior to addition to the chocolate composition of the present invention) that is sufficient to reduce and preferably substantially eliminate levels of anti-nutritive compounds therein. Advantageously, the pulse flour will have been subjected to temperatures above 90° C., preferably of around 100° C. or greater, prior to use. Any suitable heating method known in the art may be used to manufacture the pre-cooked pulse flour to be used in the present invention. In one aspect of the invention, the pulse flour has been subjected to roasting. In another aspect, the pulse flour has been subjected to extrusion cooking. Extrusion may occur under dry conditions or it may be hydro-thermal extrusion cooking.

The pulse flour used in the present invention preferably has a reduced content in anti-nutritional factors, relative to their natural content prior to processing, such that the levels of anti-nutritional factors are low enough that they do not have a significant negative impact on bioavailability or digestibility of nutrients. Anti-nutritional factors in pulses typically include phytate, enzyme inhibitors (trypsin inhibitors, chymotrypsin inhibitors, and α-amylase inhibitors), polyphenolics (including tannins), lectins, and saponins. Vicine and convicine are two anti-nutritional factors specifically associated with faba beans. The pulse four used in the present invention will preferably have a reduced trypsin inhibitor content. Trypsin inhibitor content can be measured using AOCS Official Method Ba 12-75. Advantageously, the pulse four used in the present invention has a residual trypsin inhibitor activity of less than 5 Trypsin Inhibitor Units (TIU)/mg, more preferably less than 5 TIU/mg, more preferably less than 3 TIU/mg, more preferably about 2 TIU/mg. The pulse four used in the present invention will preferably be free or substantially free of trypsin inhibitors and more preferably free or substantially free of anti-nutritional factors.

The pulse flour may advantageously have undergone a size reduction technique, such as milling or micronization, prior to being used in the present invention. Particle size is known to influence the texture and mouthfeel of chocolate. For example, if the particle size is too large, the chocolate may be perceived as “grainy”. Whereas a particle size that is too fine can result in an unpleasant “sticky” texture. Particle size reduction techniques allow the particle size of the pulse flour to be controlled and limited to a desirable range that makes it suitable for use in the chocolate making process. Preferably, the pulse flour will have an average particle size of 250 μm or less, more preferably of 200 μm or less, more preferably of 150 or less, more preferably of 100 μm or less. For example, the particle size of the pulse flour used in the present invention may be between 10 and 250 μm, between 20 and 200 μm, between 30 and 150 μm or between 40 and 100 μm. The particle size of the pulse flour, and other chocolate ingredients, will be reduced further during the refining step of the chocolate making process such that particles in the final (ready-to-eat) composition have an average particle size of about 20-50 μm, preferably 20-40 μm.

Micronization may be used to provide very fine particles (e.g. less than 100 microns). Micronization methods are known in the industry. For example, WO2017/167965, which is incorporated herein by reference, describes a micronized “bran-like” material. Micronization involves heat-treating the material and then milling at high speed (e.g. at least 3000 rpm) using a high performance mill, such as a cell mill or jet mill.

In one aspect of the invention, the pulse flour is both pre-cooked and size-reduced prior to use in the invention. In a preferred aspect of the invention, the pulse flour is subjected to extrusion cooking and micronization. In a particularly preferred aspect, the pulse flour is extruded and micronized pea and/or fava bean flour. One, non-limiting, example of an extruded, micronized pea flour is Sativa® 32/100 (sold by Sotexpro). One, non-limiting example of an extruded, micronized faba bean flour is Fabatex33 (sold by Sotexpro).

### Use of Pulse Flour for Reducing Sugar Content

The applicant has determined that pulse flour, preferably pre-cooked pulse flour, may be used as a bulking agent in chocolate for reducing sugar content. Thus, the present invention provides bulking agents comprising or consisting of pulse flour and reduced-sugar chocolate compositions comprising said bulking agents.

The bulking agent of the present invention may be used as a full or partial replacement for sugar in a recipe for a chocolate composition.

The reduced-sugar chocolate compositions may comprise from 3 to 20 wt % pulse flour, more preferably from 3 to 15 wt %, or more preferably from 4 to 10 wt %, or more preferably from 5 to 7 wt %, or more preferably around 6 wt %. Preferably, the pulse flour is pre-cooked pulse flour.

The chocolate compositions of the present invention preferably have a lower content of total sugars than equivalent, traditionally manufactured chocolates. The terms “total sugars” and “total sugar content” as used herein refer to the sum of all the sugars in the chocolate composition. This may include sugars that are intentionally added to the chocolate as well as sugars that are intrinsic to other ingredients in the chocolate. Total sugars do not include polyols or high intensity sweeteners which may sometimes be used in reduced sugar chocolate recipes.

Non-limiting examples of sugars that may be used in accordance with the present invention, and which may make up the total sugar content of the chocolate composition, include: monosaccharides, such as glucose, dextrose, fructose, allulose or galactose; disaccharides such as sucrose, lactose or maltose; as well as honey, agave syrup, maple syrup, and combinations of two or more thereof.

The term “sucrose” as used herein includes sucrose in various forms including but not limited to standard (e.g. granulated or crystalline) table sugar, powdered sugar, caster sugar, icing sugar, sugar syrup, silk sugar, unrefined sugar, raw sugar cane, and molasses.

To comply with legal standards for reduced-sugar chocolates, the content of total sugars in the chocolate composition of the invention is preferably at least 30% less than that of equivalent commercial chocolates.

In one aspect, the total sugar content of a milk variety of a reduced-sugar chocolate composition in accordance with the invention is around 45 wt % or less, or preferably around 40 wt % or less, or more preferably around 36 wt % or less.

In another aspect, the total sugar content of a dark chocolate variety of a reduced-sugar chocolate composition in accordance with the invention is around 35 wt % or less, or preferably around 30 wt % or less, or preferably around 27 wt % or less.

Advantageously, by using the bulking agent of the present invention, the sugar content of the chocolate composition can be reduced without increasing the calorie content or energy value of the chocolate. Thus, the fat (e.g. cocoa butter) content of reduced-sugar chocolate compositions according to the invention is preferably substantially the same or similar to the fat content of equivalent commercial chocolates, such that the energy value of the chocolate is not increased. The total fat content of the reduced-sugar chocolate composition is determined by the intended application. For example, the total fat content may be around 40 wt % or less for milk chocolate bars, but may be higher for other applications, such as ice cream coatings. A person skilled in the field of the invention would be familiar with the fat content required for various applications.

The chocolate composition may also comprise additional bulking agents that do not contain pulse flour. For example, one or more additional bulking agents may be added to further improve the texture and/or organoleptic properties of the chocolate and/or to facilitate the refining step of the manufacturing process. By using a combination of pulse flour containing and non-pulse flour containing bulking agents, the taste attributed to the pulse flour is retained whilst also benefiting from the advantages of the other bulking agents used.

Any suitable bulking agent known in the art may be used in combination with the bulking agent of the present invention, including soluble and/or insoluble fibres. Non-limiting examples of “insoluble fibre” that may be used in accordance with the present invention are dietary fibres, cereal fibres and/or other plant fibres. Non-limiting examples of “soluble fibre” that may be used in accordance with the present invention are resistant dextrin, resistant/modified maltodextrin, polydextrose, β-glucan, galactomannan, fructo-oligosaccharides, oligofructose, gluco-oligosaccharide, galacto-oligosaccharides, MOS (mannose-oligosaccharides, also known in the art as mannan-oligosaccharides or manno-oligosaccharides), psyllium, inulin. Alternatively, the additional bulking agent may be maltodextrin or glucose syrup. Preferably, the additional bulking agent is resistant dextrin.

### Use of Pulse Flour for Flavour

Aside from being a good bulking agent, the applicant has unexpectedly found that pre-cooked pulse flour also provides a pleasant taste to chocolate, which has been variously described as “biscuity”, “popcorn-like” or “malty”. Moreover, it does not have the characteristic bitter taste typically associated with protein isolates or protein concentrates. This unique flavour profile is expected to have wide appeal amongst consumers. The applicant thus envisages the use of pre-cooked pulse flour as a new flavour compound or flavouring agent for use in chocolate recipes.

The pulse flour may be used as a flavour compound in reduced sugar chocolate compositions, reduced dairy or dairy free chocolate compositions (as described below) and normal, i.e. non-sugar reduced, chocolate compositions.

In one aspect, pre-cooked pulse flour may be used in a chocolate composition solely or primarily for flavour. When used in this way, the pulse flour does not necessarily replace other ingredients in the chocolate recipe (e.g. sugar or milk solids). The pulse flour may be added alongside other flavour compounds.

### Other Applications

The pulse flour of the present invention is also useful for the production of vegan (dairy-free) chocolate compositions because the pulse flour can be used to replace all or part of the milk solids from a non-vegan chocolate recipe.

Accordingly, the cocoa compositions of the present invention may have a reduced dairy content. For instance, they may advantageously comprise milk solids in an amount of less than 5% by weight, preferably in an amount of less than 4% by weight, more preferably less than 3% by weight, more preferably less than 2% by weight, more preferably less than 1% by weight. In one aspect, the cocoa composition of the invention will be substantially free of milk solids.

As used herein, “milk” refers to milks of animal and particularly mammalian origin (e.g. cow, buffalo, sheep, and/or goat milk) and “milk solids” refers to ingredients obtained by partly or wholly dehydrating whole milk, semi- or fully-skimmed milk, cream, or from partly or wholly dehydrated cream, butter or milk fat, and any derivatives thereof including, but not limited to, milk fat fractions, lactose, whey, whey powder, caseinate, and/or milk hydrolysates.

Moreover, the relatively high protein content of pulse flours means that they can be used to produce protein-enriched chocolate compositions. Currently, there is an increasing preference amongst consumers for high protein snacks, which are perceived as being healthier, for example due to suggested links between protein and muscle gain.

The vegan or protein-enriched chocolate compositions may or may not also have reduced sugar content.

### Aspects of the Invention

The following are non-limiting and non-exhaustive aspects of the present invention:

Aspect 1. A bulking agent comprising pulse flour for use in chocolate.

Aspect 2. A bulking agent according to aspect 1, consisting of pulse flour.

Aspect 3. A bulking agent according to aspect 1 or aspect 2, wherein the pulse flour is pre-cooked.

Aspect 4. A bulking agent according to aspect 3, wherein the pulse flour has been subjected to extrusion cooking.

Aspect 5. A bulking agent according to any one of the preceding aspects, wherein the pulse flour has been subjected to a particle size reduction technique.

Aspect 6. A bulking agent according to aspect 5, wherein the particle size reduction technique is milling and/or micronization.

Aspect 7. A bulking agent according to any one of the preceding aspects, wherein the pulse flour has been extruded and micronized.

Aspect 8. A bulking agent according to any one of the preceding aspect, wherein the pulse flour is selected from bean flour, pea flour, chickpea flour, lentil flour, vetch flour, lupine flour, and mixtures thereof.

Aspect 9. A bulking agent according to aspect 8, wherein the pulse flour is selected from pea flour, faba bean flour, and mixtures thereof.

Aspect 10. A bulking agent according to any one of the preceding aspects, wherein the pulse flour is free or substantially free from anti-nutritional factors.

Aspect 11. Use of the bulking agent of any one of the preceding aspects as a full or partial replacement for sugar and/or milk solids in a recipe for a chocolate composition, and/or to enrich the protein content of a chocolate composition.

Aspect 12. A chocolate composition comprising the bulking agent of any one of the preceding aspects.

Aspect 13. A chocolate composition according to aspect 12, comprising from 3 to 20 wt % pulse flour.

Aspect 14. A chocolate composition according to aspect 12 or 13, which is a sugar-reduced and/or dairy-free chocolate composition, preferably comprising 45 wt % or less total sugars and/or less than 5 wt % milk solids.

Aspect 15. A chocolate composition according to any one of aspect 12 to 14, further comprising an additional bulking agent.

### EXAMPLES

### Measurement Methods

### 1. Particle Size

Particle size for molten chocolate was measured using a micrometer. A small amount of chocolate was placed on the measuring surface of a Mitutoyo micrometer (0-25 mm). By pressing, an indication of the size of the largest non-compressible particles can be measured. The value is given in μm, and is known to represent approximately the D84 particle size.

### 2. Fat Content

A refractometer RE40—METTLER TOLEDO was used to determine the refractive index at 20° C. of the filtrate resulting from the extraction of about 2 g of chocolate with 4.5 g of Bromo-1-naphtalene Merck 806210. The fat was extracted from the chocolate sample for about 20 minutes at 50° C. Depending on the refractive index obtained, the total fat content was then calculated (see Leithe, W., u. J. H. Heinz: Refraktometrische Fettbestimmung in Kakaowaren. Z. Unter-such. Lebensmittel 71, 414-418 (1936)).

### 3. Colour

Colour values are expressed as Hunter L, -a and -b values, where the L value represents the “brightness” of the product (black/white scale), the “a” value represents the amount of green/red and the “b” value represents the amount of yellow/blue. The quotient of “a” over “b” represents the redness of the product. The following procedure was used to determine the colour value of chocolate. A small amount of chocolate at 50° C. was poured into an optically neutral petri dish (diameter 55 mm) right to the top. The petri dish was then placed on a calibrated spectrocolorimeter Minolta CM2500D (Illuminant D65, 10° observer, read values in Hunter L -a and b values, software Minolta SPECTRA MAGIC version 1.00). The L, a and b-values of the chocolate sample were then measured by the device and recorded.

### 4. Flow Properties

The flow behaviour of the chocolate was measured by ICA Analytical method 46 (2000) “Viscosity of Cocoa and Chocolate Products”, available from CAOBISCO Brussels, using a rheometer RM200 (Lamy Rheology Instruments, Champagne au Mont d'Or, France). This is a shear-rate imposed rheometer whereby its speed ranges from 0.3 to 1500 rpm and the torque from 0.05 to 30 mNm. The temperature of the measuring cell is kept at 40° C. A small amount of chocolate is brought into the tube. After pre-shearing the chocolate for 10 min at 5 s-1, a stepped flow procedure is applied by increasing and decreasing the shear rate while measuring the shear stress. The Casson model is used to define Casson Yield stress and Casson Viscosity for recipes with a fat content below 38%. For recipes with a fat content higher than 38% a polynomial model is used.

### 5. Sensory Evaluation

All chocolate samples were tasted by experienced chocolate engineers, customers, and a trained panel of experts.

### Example 1

5 kg batches of milk chocolates were prepared containing varying amounts of pulse flour using the ratios shown in Table 1. The pre-cooked faba bean flour (Fabatex 33) and pea flour (Saliva® 32/100) were obtained from Sotexpro.

The chocolates were manufactured using the following conventional method.
Mixing: all the dry ingredients, the cocoa liquor and a part of the cocoa butter were mixed together for 10 minutes in a Hobart mixer at a temperature of 45 to 50° C. The cocoa butter addition was adapted on a case-by-case basis to get a correct texture for refining. Optimal fat content in the mixer was 23-27%.
Refining: the chocolate paste was then refined in a Buhler three roll refiner, in order to produce refiner flakes having a reduced particle size between 20 and 24 μm
Conching: the refiner flakes were then dry-conched for 6 hours at a temperature of 65° C. in a 5 kg batch Buhler Elkolino monoshaft conche running clockwise at a rotor speed of 1000 rpm. Additional cocoa butter was added when needed during the filling of the conche, in order to ensure a proper mechanical shearing and a good flavour development thanks to the optimal texture in conche. At the end of the dry conching, remaining cocoa butter was added to the conche. The mixture was then wet-conched for 30 min at 1500 rpm counter-clockwise at a temperature of 45° C. The chocolate mass was then unloaded.
The viscosity and yield stress value of the chocolate were adjusted to the required specifications by adding cocoa butter and/or emulsifiers.
After adjustment of the rheology, the chocolate underwent a hand tempering process and was moulded into bars. Tempering involves the controlled heating and cooling of the mixture to selectively cause the crystallisation of the cocoa butter in the preferred crystalline form V.

TABLE 1
Milk chocolate compositions comprising pulse flour

| Ingredients | | | | | | |
|---|---|---|---|---|---|---|
| (%) | Recipe 1 | Recipe 2 | Recipe 3 | Recipe 4 | Recipe 5 | Recipe 6 |
| Icing sugar | 26.49 | 27.5 | 26.29 | 27.7 | 29 | 27.99 |
| Cocoa mass | 11.32 | 13.24 | 11.32 | 11.32 | 11.52 | 11.32 |
| Resistant | 11.9 | 11.17 | 12.1 | | 12.94 | |
| Dextrin | | | | | | |
| Cocoa butter | 19.7 | 27 | 19.7 | 19.99 | 19.4 | 19.5 |
| Faba bean | 6 | | | | 5.53 | 16.6 |
| flour | | | | | | |
| Pea flour | | 5.53 | 6 | 16.4 | | |
| Whole milk | 23.98 | 15.18 | 23.98 | 23.98 | 21 | 23.98 |
| powder | | | | | | |
| (26% fat) | | | | | | |
| Soya lecithin | 0.6 | 0.37 | 0.6 | 0.6 | 0.6 | 0.6 |
| Vanilla | 0.01 | 0.01 | 0.01 | 0.01 | 0.01 | 0.01 |
| flavouring | | | | | | |
| TOTAL | 100 | 100 | 100 | 100 | 100 | 100 |

Quantitative testing results are shown in Table 2. The viscosity, yield stress, and colour of all of the prepared chocolates were within an acceptable range for milk chocolate bars. The sugar content was lower than equivalent commercial chocolates at between 34-39 wt %, whilst the fat content was similar to commercial chocolates at between 31 and 39 wt %.

The chocolates then underwent sensory evaluation as outlined above. The panel reported good texture, mouthfeel, taste and sweetness. Words like “creamy”, and “velvety” were used to describe the texture, whilst the taste was described as “pop-corn”, “malt”, “cereal”, “coffee”, “roasted” which tasters generally found very pleasant.

TABLE 2
Quantitative measurements of chocolate compositions
comprising pulse flour.

| | Recipe 1 | Recipe 2 | Recipe 3 | Recipe 4 | Recipe 5 | Recipe 6 |
|---|---|---|---|---|---|---|
| Fat (%) | 32.71 | 38.44 | 32.65 | 33.15 | 31.73 | 32.83 |
| Sugar (%) | 36.64 | 34.58 | 36.59 | 36.62 | 38.25 | 36.58 |
| Viscosity | 1.92 | 1.08 | 2.18 | 1.68 | 1.51 | 2.15 |
| (Pa · s) | | | | | | |
| Yield | 19.4 | 9.3 | 16.4 | 1.6 | 15.8 | 13.1 |
| value (Pa) | | | | | | |
| Particle | 24 | 23 | 32 | 39 | 24 | 46 |
| size (μm) | | | | | | |
| L* | 48.7 | | 47.95 | 47.17 | | 47.15 |
| a* | 9.71 | | 9.56 | 9.52 | | 9.35 |
| b* | 16.02 | | 12.84 | 14.76 | | 14.54 |

The features disclosed in the foregoing description, or the following claims, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

### Example 2

A 5 kg batch of vegan chocolate according to the invention was prepared with pea flour (Sativa® 32/100 from Sotexpro) following the recipe shown in Table 3.

The chocolate was manufactured using the method described in Example 1. Quantitative testing results are also shown in Table 3. The viscosity, yield stress, and colour of all of the prepared chocolates were within an acceptable range for milk chocolate bars, despite the absence of milk solids. The fat content was similar to commercial milk chocolates at between 31 and 39 wt %.

TABLE 3
Vegan chocolate composition comprising pulse flour

| Ingredients (%) | Recipe 7 |
|---|---|
| Icing sugar | 43.96 |
| Cocoa mass | 14.31 |
| Resistant dextrin | 9.38 |
| Cocoa butter | 27.08 |
| Pea flour Sativa 32/100 | 4.88 |
| Soya lecithin | 0.39 |
| Natural vanilla flavour | 0.01 |
| Total Fat Content (%) | 35.15 |
| Total Sugar Content (%) | 45.56 |
| Viscosity (Pa · s) | 0.62 |
| Yield value (Pa) | 7.35 |
| Particle size (μm) | 22 |
| L | 44.63 |
| a | 9.65 |
| b | 14.42 |

The chocolates then underwent sensory evaluation as outlined above. The panel reported good texture, mouthfeel, taste and sweetness. Descriptors such as “slightly creamy”, “slightly milky”, “malty” and with a coconut taste were used to define the sensory qualities of the chocolate composition. The creamy and milky descriptors were considered particularly surprising and positive for a dairy-free recipe. Overall, it was rated as having a very pleasant taste.

1. A chocolate composition comprising pulse flour.

2. The chocolate composition according to claim 1, comprising from 3 to 20 wt % pulse flour.

3. The chocolate composition according to claim 1, wherein the pulse flour is pre-cooked.

4. The chocolate composition according to claim 3, wherein the pulse flour has been subjected to extrusion cooking.

5. The chocolate composition according to claim 1, wherein the pulse flour has been subjected to particle size reduction.

6. The chocolate composition according to claim 5, wherein the pulse flour has been subjected to milling and/or micronization.

7. The chocolate composition according to claim 1, wherein the pulse flour has been pre-cooked and subjected to particle size reduction.

8. The chocolate composition according to claim 1, wherein the pulse flour is selected from the group consisting of bean flour, pea flour, chickpea flour, lentil flour, vetch flour, lupine flour, and mixtures thereof.

9. The chocolate composition according to claim 1, wherein the pulse flour is free or substantially free from anti-nutritional factors.

10. The chocolate composition according to claim 1, which is a sugar-reduced chocolate composition.

11. The chocolate composition according to claim 1, which is a dairy-reduced chocolate composition.

12. The chocolate composition according to claim 1, further comprising one or more soluble and/or insoluble fibres.

13. The chocolate composition according to claim 1, further comprising resistant dextrin.

14. Use of pulse flour as a full or partial replacement for sugar and/or milk solids in a chocolate composition, and/or to enrich the protein content of a chocolate composition, and/or as a flavouring agent in a chocolate composition.

15. The chocolate composition according to claim 1, wherein the pulse flour has been extruded and micronized.

16. The chocolate composition according to claim 1, wherein the pulse flour is selected from the group consisting of pea flour, faba bean flour, and mixtures thereof.

17. The chocolate composition according to claim 1, comprising 45 wt % or less total sugars.

18. The chocolate composition according to claim 1, comprising less than 5 wt % milk solids.
